(19) United States
(12) Patent Application Publication
(10) Pub. No.: US 2017/0010955 A1
(43) Pub. Date: Jan. 12, 2017

(54) SYSTEM AND METHOD FOR FACILITATING CHANGE BASED TESTING OF A SOFTWARE CODE USING ANNOTATIONS

(71) Applicant: HCL Technologies Limited, Uttar Pradesh (IN)

(72) Inventors: Simy CHACKO, Hyderabad (IN); Suresh Naidu PONAKALA, Hyderabad (IN); S U M Prasad DHANYAMRAJU, Hyderabad (IN); Shiva SHOLAYAPPAN, Hyderabad (IN)

(21) Appl. No.: 15/178,542

(22) Filed: Jun. 9, 2016

(30) Foreign Application Priority Data
Jul. 7, 2015 (IN) 2056/DEL/2015

(51) Int. Cl. G06F 11/36; G06F 9/44

(52) U.S. Cl. CPC G06F 11/3672; G06F 8/73

(57) ABSTRACT

The present disclosure discloses system and method for facilitating change based testing of a software code using annotations. The software code modified by a first-user may be received. The modification is done at a code level in the software code. The system prompts the first-user to insert annotations corresponding to the modification. Further, the system itself inserts a hash values corresponding to the modification. Further, the annotations are encrypted by the system. Further, the software code is converted into software binary comprising the tin notations and the hash value. The system further enables a second user to trace the modifications by comparing the hash value with a previous hash value, extracting the annotations, and identifying code elements impacted due to the modification. Further, the code elements modified are mapped with their respective operation attributes. Based on the mapping, traceability matrix is generated which is utilized by the second user for testing.

### CROSS-REFERENCE TO RELATED APPLICATIONS AND PRIORITY

The present application claims benefit from Indian Complete Patent Application No. 2056/DEL/2015, filed on Jul. 7, 2015, the entirety of which is hereby incorporated by reference.

The present subject matter described herein, in general, relates to a system and method for testing a software code, more specifically, a change based testing of the software code.

### BACKGROUND

In the software development environment, a software code or a software program has to go through various changes. These changes are generally done at the time of developing the software or even after its development. The changes are done during the maintenance phase by software development team. The changes are at done at code level within the software code to meet some specific requirements. Once the changes are done, the software development team passes the modified software code to a software testing team for testing the software code. After the modification, the software testing team expects the details of the changes one by the software development team. Thus, while passing the modified software code, the software development team informs the software testing team about the changes done in the software code or about any additional features added. This may be done by a formal note or through an informal communication like release notes.

There may be gap between what the software development team wanted to convey in their communication and what exactly the software testing team has received. This may lead to confusion for the software testing team while performing the testing of the software code. For example, the software development team may communicate about what features are added in the software code or what issues/fixes are addressed, but, they do not communicate what exactly changes have been done in the software code. Sometimes the fix could be in some module of the software code where the actual problem could be somewhere else. For example, there can be login failure because some bug/issue in audit-log module of the software code. But, while communicating, the software development team may release the formal note saying that issue related to login is fixed. Whereas, the actual change was done in the audit-log module. So, due to such miscommunication, the software testing team may not know what, exact changes has been done in the modified software code for making his/her testing effective. Thus, the software testing team has to go for test all approach. This means that all the test cases and conditions are considered for testing the modified software code.

### SUMMARY

This summary is provided to introduce aspects related to a system and method for facilitating change based testing of a software code are further described below in the detailed description. This summary is not intended to identify essential features of subject matter nor is it intended for use in determining or limiting the scope of the subject matter.

In one implementation, a system for facilitating change based testing of a software code is disclosed. The system may comprise a processor and a memory coupled to the processor. The processor may execute a set of instructions stored in the memory to receive a software code being modified by a first user. The software code comprises a plurality of annotations inserted by the first user. Further, the plurality of annotations corresponds to a plurality of modules present in the software code. Further, each module may be at least one of a method, a function, and a subroutine associated with the software code. Further, each module may comprise a plurality of code elements. Further, each code element is associated with at least one operational attribute of a plurality of operational attributes associated with the software code. The processor may further execute a set of instructions to insert a hash value corresponding to at least one module, of the plurality of modules, modified by the first user. The processor may further execute a set of instructions to convert the software code into a software binary comprising the plurality of annotations, in the encrypted form, arid the bash value. Further, the processor may execute a set of instructions to enable a second user to trace the modification done by the first user in the software code by performing comparing, extracting, and identifying, steps. In the comparing step, the hash value of the at least one module in the software binary is compared with a hash value of the at least one module in a previous binary version of the software code. Further, in the extracting step, the one or more annotations, or the plurality of annotations, associated with the at least one module of the software binary are extracted based on the comparison. Further identifying step, the one or more code elements, in, the at least one module, are identified which are impacted based upon the modification done in the least one module. Further, the one or more code elements are identified based on the modification. The processor may further execute the set of instructions to map the one or more code elements with the one or more operational attributes of the plurality of operational attributes. Further, the processor may further execute the set of instructions to generate a traceability matrix based on the mapping. Further, the traceability matrix generated may be used by the second user for tracking the modifications in the one or more code elements, thereby facilitating a change based testing of the software code.

In another implementation, a method or'fat facilitating a change based testing of a software code is disclosed. The method may con processor, software code being modified by a first user. Further, the software code comprises a plurality of annotations inserted by the first user. Further, the plurality of annotations corresponds to a plurality of modules present in the software code. Further, each module may be at least one of a method, a function, and a subroutine associated with the software code. Further, each module may comprise plurality a s code elements. Further, each code element may be associated with at least one operational attribute of a plurality of operational attributes associated with the software code. The method may further comprise a program code for inserting, by the processor, is hash value corresponding to at least one module, of the plurality of modules, modified by the first user, The method may further comprise a step of converting, by the processor, the software code into a software binary comprising the plurality of annotations, in the encrypted form, and the hash value. Further, the method may comprise enabling, by the processor, a second user to trace the modification done by the first user in the software code by performing the steps of comparing, extracting, and identifying. In the step of comparing, the hash value of the at least one module in the software binary is compared with a hash value of the at least one module in a previous binary version of the software code. Further, in the step of extracting, the one or more annotations, of the plurality of annotations, associated with the at least one module of the software binary are extracted based on the comparison. Further, in the step of identifying, the one or more code elements, in the at least one module, are identified which are impacted based upon the modification done in the least one module. Further, the one or more code elements are identified bawd on the modification. Further, the may comprise a step of mapping, by the processor, the one or more code elements with one or more operational attributes of the plurality of operational attribute. The method may further comprise a step of generating, by the processor, a traceability matrix based on the mapping. The traceability matrix may be used by the second user in order to test the software code being modified by the first user.

In yet another implementation, a non-transitory readable medium embodying a program executable in a computing device for facilitating change based testing of a software code is disclosed. The program may comprise a program code for receiving a software code being modified by a first user. Further, the software code comprises a plurality of annotations inserted by the first user. The plurality of annotations may correspond to a plurality of modules present in the software code. Further, each module may be at least one of a method, a function, and a subroutine. Further, each module comprises plurality of code elements. Further, each code element is associated with at least one operational attribute of as plurality of operational attributes associated with the software code. The program may further comprise a program code for inserting is hash value corresponding to at least one module, of die plurality of modules, modified by the first user. Further, the bash value is indicative of modification done in the at least one module. The program may further comprise a program code for converting the software code into a software binary comprising the plurality of annotations, in an encrypted form, and the hash value. Further, the program may comprise a program code for enabling a second user to trace the modification done by the first user in the software code by performing steps of comparing, extracting, and identifying, in the step of comparing, the hash value of the at least one module in the software binary is compared with a hash value of the at least one module in a previous binary version of the software code. Further, in the step of extracting, the one or more annotations, of the plurality of annotations, associated with the at least one module of the software binary are extracted based on the comparison. Further, in the step of identifying, the one or more code elements, in the at least one module, are identified which are impacted based upon the modification done in the least one module. Further, the one or more code elements are identified based on the modification. Further, the program may comprise a program code for mapping the one or more code elements with one or more operational attributes of the plurality of operational attributes. The program code may further comprise a program code for generating a traceability man the mapping. The traceability matrix may be used by the second user to test the software code being modified by the first user.

The detailed description is described with reference to the accompanying figures. In the figures, the leftmost digit(s) of a reference number identifies the figure in which the reference number first appears. The same numbers are used throughout the drawings to refer like features and components.

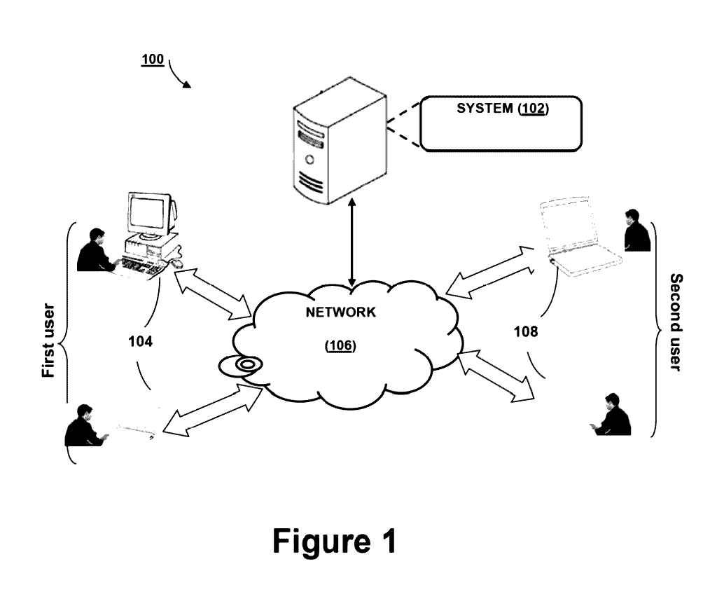

FIG. 1 illustrates a network implementation of a system for facilitating a change based testing of a software code, in accordance with an embodiment of the present disclosure.

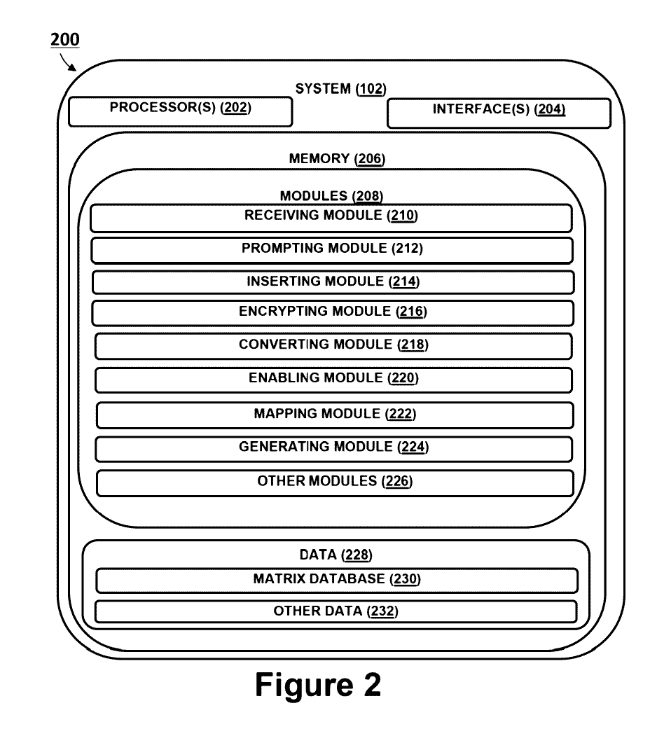

FIG. 2 illustrates the system, in accordance with an embodiment of the present subject matter.

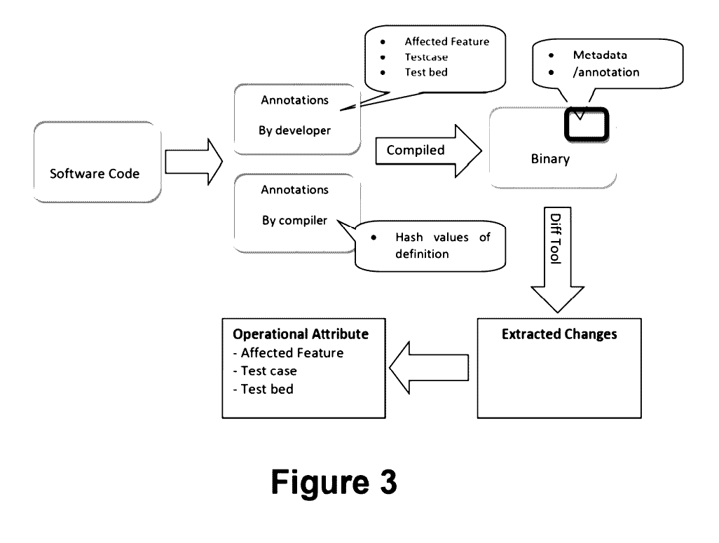

FIG. 3 illustrates flow of the working of the system, in accordance with an embodiment of the present disclosure.

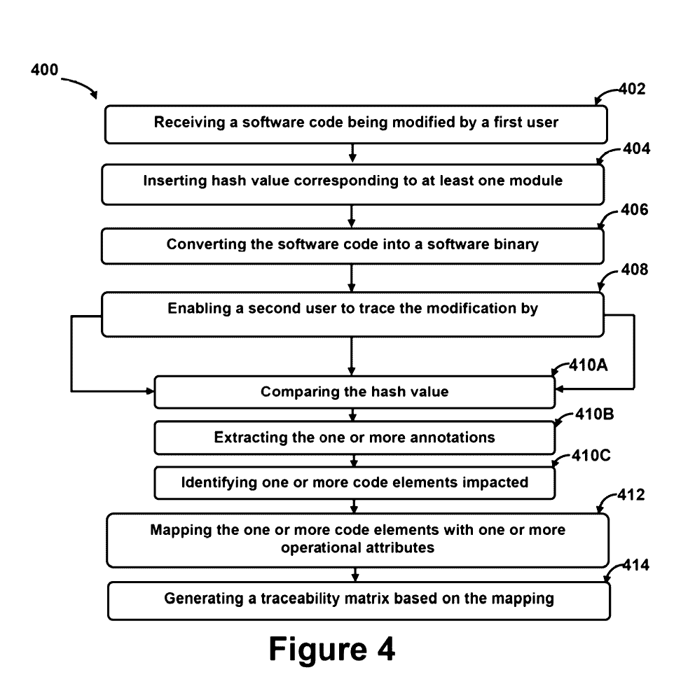

FIG. 4 illustrates a method for facilitating the change based testing of the software code, in accordance with an embodiment of the present disclosure.

### DETAILED DESCRIPTION

Referring to FIG. 1, a network implementation 100 of a system 102 for facilitating a change based testing is illustrated, in accordance with an embodiment of the present subject matter. In one embodiment, the system 102 facilitates the change based testing using annotations. Although the present subject matter is explained considering that the system 102 is implemented as a software application on a server, it may be understood that the system 102 may also be implemented as a variety of computing systems, such as a laptop computer, a desktop computer, a notebook a workstation, a mainframe computer, a server, a network server, a tablet, a mobile phone, a robot and the like. In one implementation, the system 102 may be implemented in a cloud-based environment. It will be understood that the system 102 may be accessed by multiple first users and second users through first-user devices 104 and second-user devices 108 respectively. Examples of the first-user device and the second-user device may include, but are not limited to, a portable computer, a personal digital assistant, a handheld device, and a workstation.

In one implementation, the network 106 may he a wireless network, a wired network or a combination thereof. The network 106 can be implemented as one of the different types of networks, such as intranet, local area network (LAN), wide area network (WAN), the internet, and the like The network 106 may either he a dedicated network or a shared network. The shared network represents an association of the different types of networks that use a variety of protocols, for example, Hypertext Transfer Protocol (HTTP). Transmission Control Protocol/Internet Protocol (TCP/IP). Wireless Application Protocol (WAP), and the like, to communicate with one another. Further the network 106 may include a variety of network devices, including routers, bridges, servers, computing devices, storage devices, and the like.

Referring now to FIG. 2, the system 102 is illustrated in accordance with an embodiment of present disclosure. In one embodiment, the system 102 may include at least one processor 202, an input/output (I/O) interface 304, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The interface 204 may include a variety of software and hardware interfaces, for example, a web interface, as graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc, and wireless networks, such as WLAN, cellular, or satellite. The ISO interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc DVDs) and magnetic tapes. The memory 206 may include modules 208 which may perform particular tasks or implement particular abstract data types.

The modules 208 include routines, programs, objects, components, data structures, etc., which perform particular tasks or implement particular abstract data types. In one implementation, the modules 208 may include a receiving module 210, a prompting module 212, an inserting module 214, an encrypting module 216, a converting module 218, an enabling module 220, a mapping module 222, a generating module 224, and other modules 226. The other modules 226 may include programs or coded instructions that supplement applications and functions of the system 102.

The data 228, amongst other things, serves as a repository for storing data processed, received, and generated by one or more of the modules 208. The data 228 may also include a matrix database 230, and other data 232.

According to embodiments of present disclosure, the system 102 facilitates the change based testing of the software code using annotations. In the software development process, different teams are involved. Mainly, the software development team and software testing team plays vital role during the software development and their release. Software development means writing a code, specifically, “a software code”. During or after the software development, the members of the software development team may make some changes or modifications or may add additional features in the software code to comply with some specific requirements. After doing the changes, the software development team may pass the software code (modified software code) to the software testing team along with some formal note or informal communication regarding the changes done in the software code.

However, the formal note may not be sufficient for the software testing team to track the changes and understand what exactly changes have been done in the software code. This makes difficult for the software development team to focus on a specific operational attribute for performing the testing of the software code. Rather than focusing, on the specific operational attribute, the software development team has to consider all the operational attributes for testing the software code. Thus, to overcome this, the present disclosure discloses the system 102 and method for facilitating the change based testing by using annotations at a build time or compile time. This is explained in detail in subsequent paragraphs of the specifications.

In a first step, receiving module 210, of the system 102, may receive a software code being modified by the first user. Further, the software code received may comprise plurality of annotations inserted b the first user. Further, the plurality of annotations corresponds to a plurality of modules present in the software code. Further, each module may be at least one of as method, a function, and a subroutine associated with the software code. Further, each module, of the plurality of modules, comprises plurality of code elements. Each code element is associated with at least one operational attribute of as plurality of operational attributes associated with the software code. The first user 104 (referred in FIG. 1) is a member of a software development team. There may be several operational attributes like test requirement, test case, test bed, and the like which may be considered for performing the testing of the software code. For testing, traceability may be defined by the system 102 as shown in below box.

@Trace(Origdeveloper =″Bob Bee″,

| | |
|---|---|
| teamMembers | ={″Ann″, ″Dan″, ″Fran″}, |
| lastModified | =″2013-02-12″, |
| lastDev | = ″Bob Bee″, |
| Feature | = “Login” |
| SpecialTC | = {“Testcase1234”, “Testcase1234”}, |
| CRs | = {“CR2345”, “PR1234”}, |
| TestBed | = “TB50” |
| Requirement | = “Req1.2” ) |

Public Class myClass
{

//Class code goes here

}

For executing the traceability, the system 102 ma define a policy or a rule and further enforces the policy at the build time or compile time. The build time or the compile time indicates the instance or time when the member (i.e., the first user 104) of the software development team makes any modifications or add any additional features and files in the software code. The policy ensures that whenever the member (first user 104) of the software development team makes any changes on the software code, he/she is required to use annotations corresponding to those changes/modifications. The policy enforcement defined by the system 102 as shown in below box.

```
    <TRACE>
    <Maintained>
        <method> must <method>
        <ClassVarInitialization> must </ClassVarInitialization>
        <ClassVariables> optional </ClassVariables><!-- show
        warning message at compiletime -->
    </ Maintained>
    <Fields>
          <Origdeveloper type=”string” notes=”use email
          preferably”> must</Origdeveloper>
          <teamMembers type=”string list” notes=”use email
          preferably”> optional </teamMembers>
          <features type=”string list” notes=”supports
          wildcard”> must </features>
        </Fields>
</TRACE>
```

The modification is done by changing or modifying one or more code elements of the software code by the first user (FIG. 1). Thus, to embrace the policy, the prompting module. 212, of the system 102, may prompt the first user to insert the plurality of annotations (as per the policy) corresponding to the plurality of modules being modified by the first uses. Further, the plurality of annotations comprises details regarding the modification being done in the at least one module of the software code. According to embodiments of present disclosure, the system 102 generates and displays a warning message to the first user 104 when the plurality of annotations is not inserted by the first user 104.

After receiving the plurality of annotations from the first use 104, the system 102 may compile the software code. During the compilation, the inserting module 214, of the system 102 may insert a plurality of hash values corresponding to the plurality of modules in such a manner that each module has a corresponding hash value. Further, the system 102 may also enable the compiler to add hash values as an annotation at the compile time of the software code. The insertion of the hash value is shown in the below box.

@Trace(Origdeveloper =″Bob Bee″,

| | |
|---|---|
| Feature | = “Login” |
| hashMD5 | = “AABFD34761223AAA” |
| ) | |

Public String add(int a, int b) {

Return new String(a+b);

}

According to an embodiment of present disclosure, system 102 may also normal in the software code before adding the hash value as discussed above. The normalization may include removal of comments, removal of white spaces, and removal of new lines or carriage return character, replacing local variable names to var1 to varX.

Further, the system 102 may enable the compiler, of the system 102, to enforce data protection policy at the compile time. This may be important because, sometime the software code to be tested may contain some private or confidential information. Thus, the data protection policy may encrypt only the value (not the key) part of information and store as independent base64 or base16 strings. The data protection policy defined by the system 102 is shown in below box.

```
<TRACE>
    <dataprotection>
        <enabled>yes</enabled>
        <type>oneway</type>
        <testerPublicKey>4235435465476576876988798967465437564
    <testerPublicKey>
    <dataprotection>
</TRACE>
```

To enforce the data protection policy, the encrypting module 216, of the system 102, may encrypt the one or more annotations inserted in the software code by the first user.

According: to embodiments of present disclosure, the system 102 may farther enable a compiler, of the system 102, to enforce a cascading policy at the compile time of the software code. The compiler may get values from a parent code which may be inserted to a code element level as defined in the policy at the compile time. Further, the code elements may he seen in a parent-child relation model. In this model, all the methods and variables defined in a file may be seen as a child. This means that, if there are some traceability annotations present in the file level, it get cascaded to its child in the parent-child model. Further, the annotations in an interface may get cascaded to all its implementations i.e., class to its methods, variables and sub classes. The cascading policy defined by the system 102 is shown in below box.

```
    <TRACE>
    <cascade>
        <file>
        <interface>
        <parentclass>
        <class>
        <method>
    </cascade>
</TRACE>
```

After annotating the software code an inserting the hash values, the converting module 218, of the system 102, may convert the software code into software binary. The software binary may comprise the plurality of annotations (inserted by the first user 104) in the encrypted form, and the hash values. Further, examples of the software binary may comprise class, jar, war, exe, and the like. These binary files may be utilized by a second user 108 (member of software testing team as shown in FIG. 1) for tracking the changes done in the software code. As shown in FIG. 3, the diff tool that can take two versions of binary and identify what changes has been done in the software code without even accessing the software code, by just using the metadata in the binary. According to embodiments of present disclosure, the metadata may be referred as hash values of the definition which is inserted by the compiler. Further, the comparison of the two versions of the binary may result various useful information required by the second user 108. The useful information may include, but not limited to, newly identified methods, removed methods, updated methods, updated variable initialization, affected features, specific test cases, and test beds. The detail of identifying the changes by using, different versions of the software binary has been explained in subsequent paragraphs of the specification.

Thus, in the next step, the enabling module 220, of the system 102, may enable the second user 108 (member of the software testing team) to trace the modification done by the first user 104 in the software code. The tracing may he done by performing steps of comparing, extracting, and identifying. In the comparing step, a hash value of the at least one module (modified by the first user) in the software binary is compared with a hash value of the at least one module in a previous binary version of the software code. Based on the comparison, one or more annotations, of the plurality of annotations, associated with the at least one module of the software binary is extracted. Further, in the identification step, the one or more code elements (of the at least one module) impacted due to the modification done is identified.

After identification, the mapping module 222, of the system 102, maps the one or more code elements with one or more operational attributes of the plurality of operational attributes. Further, the generating, module 224, of the system 102, may generate a traceability matrix based on the mapping. The traceability matrix generated may comprise information pertaining to the changes or modifications done in the software code. Further, the second users may utilize the traceability matrix in order to test the software code being modified by the first user. This means that, the second user may quickly locate the changes done in the code elements and perform the testing by selecting and executing only those operational attributes required for the testing. Further, the traceability matrix may be stored in the matrix database 230 of the system 102.

Referring now to FIG. 4, the method of facilitating a change based testing of a software code is shown, in accordance with an embodiment of the present subject matter. The order in which the method 400 is described is not intended to be construed as a limitation, and any number of the described method blocks can be combined in any order to implement the method 400 or alternate methods. Additionally, individual blocks may he deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, a software code being modified by a first user may be received. The software code received may comprise a plurality of annotations inserted by the first user. Further, the plurality of annotations corresponds to a plurality of modules present in the software code. Further, the modules present in the software code may be at least one of a method, a function, and a subroutine. Further, each module may comprise plurality of code elements, and each code element is associated with at least one operational attribute of a plurality of operational attributes associated with the software code.

At block 404, a bash value corresponding to the at least one module, of the plurality of modules, may be inserted.

At block 406, the software code may be convened into software binary comprising the plurality of annotations, in the encrypted form, and the hash value.

At block 408, a second user may be enabled to trace the modification done by the first user in the software code. This may be done by performing steps of comparing, extracting, and identifying as shown in blocks 410A, 410B, and 410C respectively.

At block 410A, the hash value of the at least one module in the software binary is compared with a bash value of the at least one module in a previous binary version of the software code.

At block 410B, the one or more annotations, of the plurality of annotations, associated with the at: least one module of the software binary is extracted based on the comparison done in the block 410A.

At block 410C, the one or more code elements, in the at least one module, may he identified which are impacted due to the modification done in the least one module.

At block 412, the one or more code elements (modified by the first user) may be mapped with one or more operational attributes of the plurality of operational attributes.

At block 414, a traceability matrix may be generated based on the mapping. Further, the traceability matrix may be sued by the second user in order to test the software code being modified by the first user.

Although implementations fur system and method for facilitating the change based testing of the software code have been described in language specific to structural features and/or methods, it is to be understood that the appended claims are not necessarily limited to the specific features or methods described. Rather, the specific features arid methods are disclosed tis examples of implementations for facilitating the change based testing of the software code.

We claim:

1. A method for facilitating a change based testing of a software code, the method comprising:
receiving, by a processor, a software code being modified by a first user, wherein the software code comprises a plurality of annotations inserted by the first user, and wherein the plurality or annotations correspond to a plurality of modules present in the software code, and wherein each module is at least one of a method, a function, and a subroutine associated with the software code, and wherein each module comprises a plurality of code elements, and wherein each code element is associated with at least one operational attribute of a plurality of operational attributes associated with the software code;
inserting, by the processor, a hash value corresponding to at least one module, of the plurality of modules, modified by the first user;
converting, by the processor, the software code into a software binary comprising the plurality of annotations, in an encrypted form, and the hash value;
enabling, by the processor, a second user to trace the modification done by the first user in the software code by:
comparing the hash value of the at least one module in the software binary with a hash value of the at least one module in a previous binary version of the software code,
extracting one or more annotations, of the plurality of annotations, associated with the at least one module of the software binary based on the comparison, and
identifying one or more code elements, in the at least one module, impacted based upon the modification done in the at least one module, wherein the one or more code elements are identified based on the modification;
mapping, by the processor, the one or more code elements with one or more operational attributes of the plurality of operational attributes, and
generating, by the processor, a traceability matrix based on the mapping, wherein the traceability matrix is used by the second user in order to test the software code being modified by the first user.

2. The method of claim 1, wherein the first user is prompted to insert the plurality of annotations corresponding to the plurality of modules of the software code.

3. The method of claim 2, further comprising displaying a warning message to the first user when the plurality of annotations is not inserted by the first user.

4. The method of claim 1, wherein the first user is a software developer and the second user is a software tester.

5. The method of claim 1, wherein the operational attributes comprises test requirement, test case, and test bed.

6. A system 102 for facilitating a change based testing of a software code, the system 102 comprises:
a processor 202;
a memory 206 coupled to the processor 202 the processor 202 executes a set of instructions stored in the memory 206 to:
receive a software code being modified by a first user, wherein the software code comprises a plurality of annotations inserted by the first user, and wherein the plurality of annotations correspond to a plurality of modules present in the software code, and wherein each module is at least one of a method, a function, and a subroutine associated with the software code, and wherein each module comprises a plurality of code elements, and wherein each code element is associated with at least one operational attribute of a plurality of operational attributes associated with the software code;
insert a hash value corresponding to at least one module, of the plurality of modules, modified by the first user;
convert the software code into a software binary comprising the plurality of annotations, in an encrypted form, and the hash value;
enable a second user to trace the modification done by the first user in the software code by:
comparing the hash value of the at least one module in the software binary with a hash value of the at least one module in a previous binary version of the software code,
extracting one or more annotations, of the plurality of annotations, associated with the at least one module of the software binary based on the comparison, and;
identifying one or more code elements, in the at least one module, impacted based upon the modification done in the least one module, wherein the one or more code elements are identified based on the modification;
map the one or more code elements with one or more operational attributes of the plurality of operational attributes; and
generate a traceability matrix based on the mapping, wherein the traceability matrix is used by the second User in order to test the software code being modified by the first user.

7. The system 102 of claim 6, wherein the first user is prompted to insert the plurality of annotations corresponding to the plurality of modules of the software code

8. The system 102 of claim 7, further comprising displaying a warning message to the first user when the plurality of annotations is not inserted by the first user.

9. The system 102 of claim 6, wherein the first user is a software developer and the second user is a software tester.

10. The system 102 of claim 6, wherein the operational attributes comprises test requirement, test case, and test bed.

11. A non-transitory computer readable medium embodying a program executable in a computing device for facilitating a change based testing of a software code, the program comprising:
a program code for receiving a software code being modified by a first user, wherein the software code comprises a plurality of annotations inserted, by the first user, and wherein the plurality of annotations correspond to a plurality of modules present in the software code, and wherein each module is at least one of a method, a function, and a subroutine associated with the software code, and wherein each module comprises a plurality of code elements, and wherein each code element is associated with at least one operational attribute of a plurality of operational attributes associated with the software code;
a program code for inserting a hash value corresponding to at least one module, of the plurality of modules, modified by the first user;
a program code for converting the software code into a software binary comprising the plurality of annotations, in an encrypted form, and the hash value;
a program code for enabling a second user to trace the medication done by the first user in the software code by:
comparing the hash value of the at least one module in the software binary with a hash value of the at least one module in a previous binary version of the software code,
extracting one or more annotations, of the plurality of annotations, associated with the at least one module of the software binary based on the comparison, and
identifying one or more code elements, in the at least one module, impacted based upon the modification done in the least one module, wherein the one or more code elements are identified based on the modification
a program code for mapping the one or more code elements with one or more operational attributes of the plurality of operational attributes; and
a program code for generating a traceability maim based on the mapping, wherein the traceability matrix is used by the second user is order to test the software code being modified by the first user.
